(19) United States
(12) Patent Application Publication
(10) Pub. No.: US 2014/0220380 A1
(43) Pub. Date: Aug. 7, 2014

(54) SLIDE COMPONENT AND METHOD FOR PRODUCTION OF CLADDING ON A SUBSTRATE

(71) Applicants: José Valentim Lima Sarabanda, Morumbi (BR); Edmo Soares, Jundiai (BR); Juliano Avelar Araujo, Jundiai (BR)

(72) Inventors: José Valentim Lima Sarabanda, Morumbi (BR); Edmo Soares, Jundiai (BR); Juliano Avelar Araujo, Jundiai (BR)

(73) Assignees: MAHLE METAL LEVE S/A, Jundiai, Sao Paulo (BR); MAHLE INTERNATIONAL GMBH, Stuttgart (DE)

(21) Appl. No.: 14/008,095

(22) PCT Filed: Mar. 29, 2012
(86) PCT No.: PCT/EP2012/001387

§ 371 Date: Apr. 2, 2014

(30) Foreign Application Priority Data
Mar. 29, 2011 (BR) PI1101402-4

(51) Int. Cl. C23C 24/10; B23K 26/00; C23C 30/00

(52) U.S. Cl. CPC C23C 24/103; C23C 30/00; B23K 26/00
USPC 428/651; 428/652; 428/656; 219/121.64

(57) ABSTRACT

A slide component, used in internal combustion engines, provided with a metal-based substrate material and a protective liner (R), with the slide component having at least two main elements, the first one composed by an element with high resistance to corrosion, and the second element providing increase of the resistance to wear and/or presenting lower friction than the substrate material, both of them covering at least one of the surfaces of the slide component.

This invention refers to a slide component, such as a cylinder used in internal combustion engine blocks, provided with a liner layer with high resistance to corrosion.

### DESCRIPTION OF THE STATE OF THE ART

Internal combustion engines comprise several components, including the cylinder among them, which is the place where the piston displaces and where the fuel ignition occurs, originating the mechanical force that enables moving the vehicle.

As they support during their lifetime the constant deflagrations of fuel and the high temperatures which it is subject to, cylinders are manufactured from a metallic material capable of supporting these extreme operating conditions.

Due to their use, the cylinders are also subject to wear due to friction between the piston rings, the ring and its surface. Although such effect is minimized by the oil film within a tribological system that prevents the borderline contact among components during its operation, the continuous utilization raises the need for grinding the cylinders.

In internal combustion engines, the cylinder is also named as jacket, which can be translated into a cylindrical tube placed in the engine block. There are two types of jacket: dry and wet. The latter receives this name because the cooling is made by water circulation around it. Its replacement is usually easier in case of excessive wear of the material.

In regard to the cylinder materials, and specifically in terms of dry jackets, cast iron alloys are the most used ones, primarily due to their mechanical properties, such as suitable strength, good machinability, good slide and low industrial cost as it proceeds from a well-consolidated production process in the industry.

However, for a number of internal combustion engines that use Diesel as fuel, this type of material is of restricted utilization, due to the fact that conventional cast iron alloys do not provide resistance to corrosion mechanisms typical of environments where there is high content of sulfur resulting from the fuels in combination with gas recirculation systems.

One of the ways to assure the resistance to corrosion for a cylinder, in order that it provides a suitable lifetime for internal combustion engines that use diesel as fuel and gas recirculation systems, can be achieved by applying a liner layer on the base metal, in its inner diameter.

Regarding this subject, it is possible to check the existence some techniques that use the most varied liner compositions and application processes, each one aiming at optimizing the performance and endurance properties of several jacket types and configurations.

Among the documents of the state-of-the-art that have the purpose of solving the corrosion problem, we have the American document U.S. Pat. No. 4,596,282, which uses a cylinder made of steel alloy inserted into a cast iron block, where a superficial heat treatment is applied, aimed at improving not only the resistance to corrosion, but also the resistance to wear. Although this solution is apparently proposed to solve the corrosion problem, it is just a typical hardening process using thermal induction techniques, as the referred document describes the transformation of the material microstructure to bainite, and further to martensite, which provides good resistance to abrasion, but with no significant increase in terms of resistance to corrosion.

Document U.S. Pat. No. 4,596,282 has the purpose of improving the resistance to wear of any component that works in any tribological system, by applying a liner made of material changeable by friction, and comprised by three components, where the first component has 40-75% of iron, cobalt and combinations of these elements, the second component comprises near 20% of weight in one of the materials of the group that includes chromium, molybdenum, tungsten, niobium, vanadium, and combinations of chromium, molybdenum, tungsten, niobium, vanadium and titanium, and the third component comprises near 2-6% of weight in one of the materials selected from the group that includes boron, carbon and their combinations. The document also indicates that the process produces an amorphous structure by the plasma-based thermal spray processes, or by laser cladding.

Although the solution proposed by this document improves the resistance to wear of the component that operates under friction conditions, the chemical composition and effects proposed are not aimed at favoring the resistance to corrosion due to the formation of an amorphous phase and as this is a material primarily of ferrous base.

The document US 2007/0099015 describes a liner for the contact surface of a piston ring or cylinder, comprised by a mix of post-sintered compound of iron oxide and iron titanate, by sol-gel processes, electrodeposition, deposition, cladding or alloying. This liner forms a hard surface aimed at reducing the friction, and thus the wear.

Although the solution presented by this document increases the resistance to wear, when applied in a material used in aggressive environments, where for example, it is subject to corrosion and exposed to high contents of sulfur and gas recirculation, it is not applicable, as the elements used and their combinations do not contribute for increasing the resistance to corrosion.

Thus, as shown above, there is a number of solutions to increase the resistance to wear for slide components, but no solution exists presenting a slide component based on a low-cost substrate of conventional material coated with t liner provided with elements with high resistance to corrosion and that provides sliding characteristics equal or greater than that of the abovementioned substrate, especially when the corrosion is caused by environments with high content of sulfur or high level of gas recirculation, as in the case of combustion engine cylinders.

### PURPOSES OF THE INVENTION

Therefore, one of the purposes of this invention is providing a slide component, such as a cylinder of internal combustion engine block, with a substrate material coated by a liner of high resistance to corrosion, in environments where there is high content of sulfur or high level of gas recirculation, and also a slide property equivalent or greater than that of the substrate.

An additional purpose of this invention is providing a slide component with a liner resistant to corrosion, with low friction coefficient, where the liner is deposited on the substrate by using laser cladding technique.

The third purpose of this invention is providing a slide component that protects the integrity of the liner with high resistance to corrosion and the material composed by the substrate.

### BRIEF DESCRIPTION OF THE INVENTION

The purposes of this invention are achieved by a slide component, used in internal combustion engines, provided with a metal-based substrate material and a protective liner, with the slide component comprising at least two main elements, the first one composed by an element with high resistance to corrosion, and the second element providing increase of the resistance to wear and/or presenting lower friction than the substrate material, both of them covering at least one of the surfaces of the slide component.

In addition to other aspects of this invention, the characteristics mentioned above will be better understood by examples and the detailed description in the figures below.

### BRIEF DESCRIPTION OF THE DRAWINGS

Next, this invention will be detailed based on an execution example shown in the drawings. The figures illustrate:

FIG. 1—cross-section of the slide component of this invention;

FIG. 2—liner coating process of this invention;

FIG. 3—enlarged metallographic view of a laser-clad slide component, according to the concepts of this invention;

FIG. 3a—enlarged detail view of the component illustrated in FIG. 3;

FIG. 4—comparison chart of the wear in a state-of-the-art cylinder vs. two configuration variations of the cylinder object of this invention;

FIG. 5—comparison chart of the wear in a state-of-the-art ring vs. two configuration variations of the ring object of this invention;

FIG. 6—comparison chart of the wear by loss of mass of the liner in some state-of-the-art slide components vs. two configuration variations of the liner in the component object of this invention.

### DETAILED DESCRIPTION OF THE FIGURES

By considering the corrosion found on slide components, such as cylinders of internal combustion engine that use Diesel as fuel, and primarily due to the high contents of sulfur found in fuels, and also due to the high level of gas recirculation through reuse systems of the combustion chamber, this invention presents a liner provided with specific alloys against corrosion and deposited by laser cladding process, aimed at solving the problems mentioned above.

It must be preliminarily mentioned that such invention refers to a slide component 100 of a slide system to be used in internal combustion engine, which may assume the forms of piston ring (with several different specifications), cylinder, bearing shell or also any other component required or desirable.

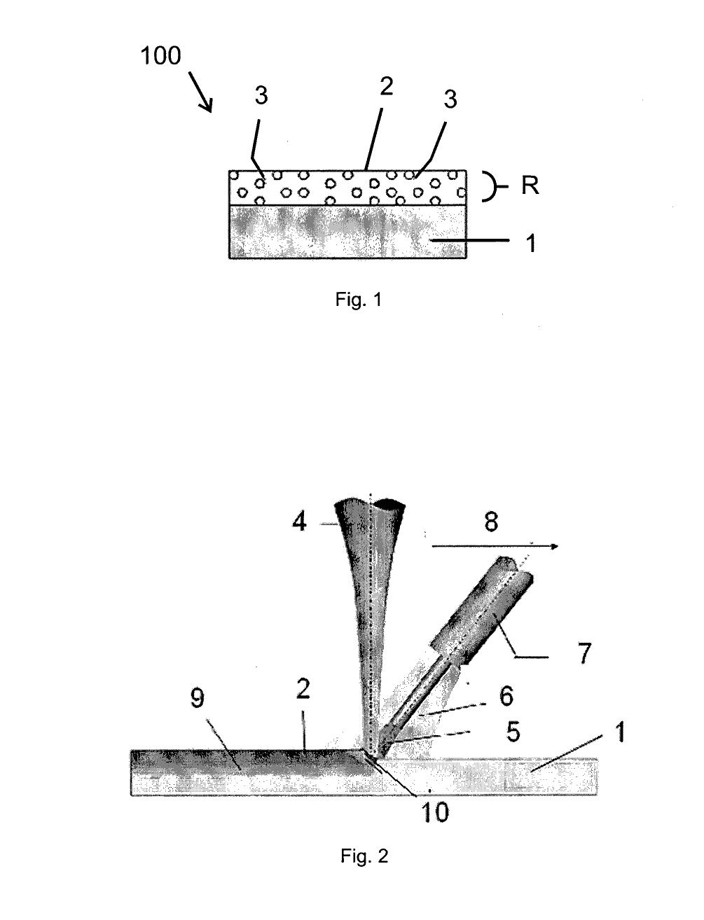

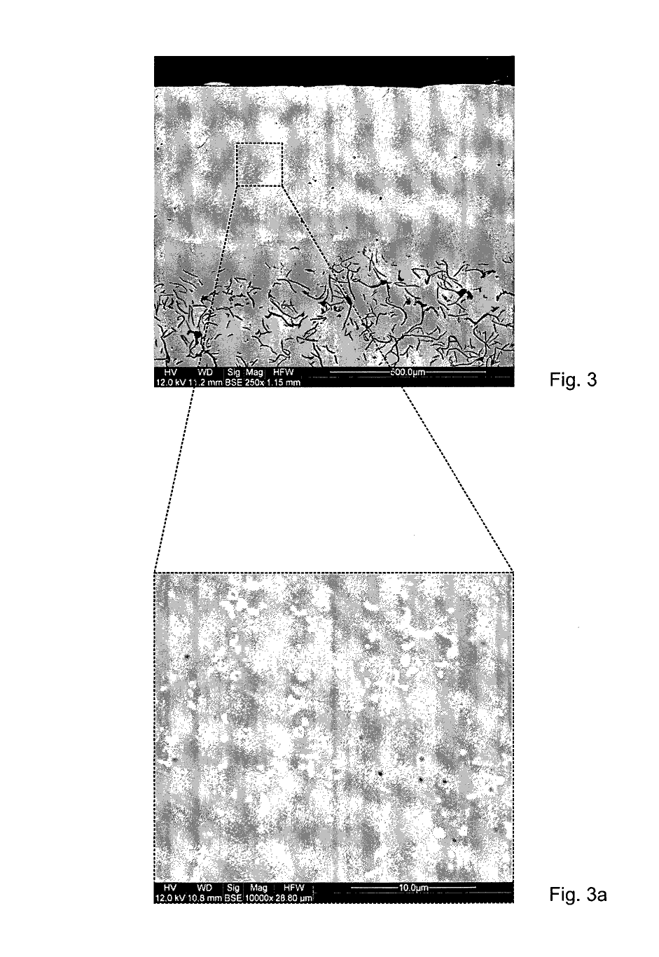

As shown in FIG. 1, the slide component 100 basically comprises a substrate material usually made of lamellar cast iron coated with a liner R, formed at least by one first element 2, and at least one second element 3, deposited on the surface of the substrate material 1. The first element 2 has a specific alloy as base, which provides high resistance to corrosion, especially due to acids generated in the system in function of the combination of high content of sulfur in the fuel, temperature and gas recirculation in the combustion chamber. Also, by aiming at achieving a resistance to wear equivalent or better than that of the substrate material, in addition to the resistance to corrosion, element 3 may comprise, in addition to the alloy, hard particles and/or solid lubricants.

The component 100 can be made of cast iron or steel, preferably cast iron that has lower industrial cost combined with high maturity of the production process for this cylinder component, and the first element 2 can be made of a cobalt- or nickel-based alloy, or also an iron-chromium-molybdenum alloy. The cast iron of the component 100 can be characterized with its graphite formation as lamellar, vermicular or nodular, as all of them meet the requirements of such application. It must be mentioned that lamellar cast iron is preferably used in this application, due to its low cost, up to 6 times lower than that of steel, combined with its easy production and good machinability.

By the other side, in regard to element 2, the cobalt- or nickel-based alloy or the iron-chromium-molybdenum alloy has been selected due to its excellent behavior in corrosive environments, as well as its easy combination with other elements. In order to achieve a cobalt- or nickel-based alloy or iron-chromium-molybdenum alloy with excellent resistance to corrosion, other metals, such as chromium, molybdenum, aluminum and tungsten can be added.

In a preferred, but not limiting way, the first element 2 is selected in the group of cobalt, nickel, chromium, molybdenum, aluminum and tungsten, in a percentage ranging from 60% to 90% of weight. More specifically, the first element 2 is a metal-based material formed by at least cobalt, nickel, chromium, molybdenum and tungsten.

The first element 2, formed on a cobalt base with addition of chromium and molybdenum is described as a more versatile alloy, since these alloys are capable of resisting to corrosion, friction, high temperatures and high solidification rates with no premature failure. By their side, iron-chromium-molybdenum alloys, with high percentage of chromium and molybdenum added between 10 and 25%, are alloys capable of resisting to wear and corrosion, with the latter being significantly lower than that of cobalt-based alloys.

In addition, by aiming at achieving a protective liner R, where in addition to resistance to corrosion, it is possible to achieving higher resistance to wear by reducing the slide friction, it is possible to add to the second element 3 hard particles and/or solid lubricants. These hard particles and/or solid lubricants must be comprised in no more than 40% in volume of liner R, comprised by the first elements 2 and 3, and must be included in the group of the following elements: boron, carbon, niobium, vanadium, titanium and sulfur. These elements will be associated to carbon, nitrogen or sulfur, by forming carbides, nitrides or sulfides, respectively. In addition, it also has the addition of carbon as solid lubricant. In other words, the array of the protective liner R exhibits a predominance of metallic elements.

Also included within the scope of the attached claims is a protective liner R that is comprised by a composite with elements selected in the group of cobalt, nickel, chromium, molybdenum, iron, aluminum and tungsten.

For a preferred concretization of this invention, the substrate material 1 is composed by lamellar cast iron and the first element 2 by a cobalt-based alloy. The cobalt-based alloy comprises at least three elements selected among chromium, tungsten, nickel, iron, molybdenum and aluminum. Element 3 also includes hard particles and/or solid lubricants formed by at least one element selected among boron, carbon, niobium, vanadium, titanium and sulfur. The array structure of element 2 is a metallic alloy that can include hard particles and/or solid lubricants embedded in this array.

To concretize this, the hardness of liner R is comprised between 300 and 1200 HV, and the thickness of liner R ranges from 50 to 500 μm.

For deposition of element 3 on the substrate material of the slide component 100, some processes can be used, such as voltaic arc welding, TIG, MIG and laser cladding, with the latter providing significant advantages in relation to the previous ones, which will be better explained later.

The oldest process used for hard lining was applied by voltaic arc welding (welding rod), but this is a manual and slow process subject to lack of uniformity or irregularities. It also requires the application of multiple layers, thus causing a thick surface, which is unnecessary. In addition, the base metal heating causes infiltration of the surface contaminants into the melting puddle of the object being coated.

MIG welding is the industry standard for application of hard liners on drilling tubes. Although this process can be automated, it requires a very experienced welder to operate. There is a high rate of dilution, which may cause cracks and dimensional deformation in the part's substrate material. There is large sensitivity to (air) drafts, incurring in higher costs with protective gases, and there is high probability of generating porosity on the weld bead, thus reducing the performance of the coat and any dirt on the part may compromise the coating quality.

Sintering furnace is another method for application of hard liner, but repairs are not possible and the process is expensive and slow.

Other methods, such as hexavalent chromium deposition generate difficulties in function of the low deposition rate and penetration power of the chromium in complex geometries, as that proposed for the cylinder. The process is being abandoned due to the deposition time, need for multiple layers, lack of uniformity and unhealthiness, in addition to environmental issues.

The high-velocity oxygen fuel (HVOF) thermal spray process is used in the oil industry to replace the chromium electro-deposition on items, such as ball valves, hydraulic cylinders, chucks, feed channel and tensioning rods for offshore platforms. For application in cylinders, the major disadvantages include high level of porosity, enabling that the combustion gases reach the substrate and promote oxidation and eventual detachment of the liner, in addition of high heat rates inherent to this process, which can cause deformation of the substrate material.

Another point is the low flexibility of the granulation of the powder used. When this flexibility is very low, clogging of the thermal spray deposition system occurs, and when it is very high, fusion of this particle does not occur, thus reducing its adherence on the work part. Also, the materials normally used for such process include ferrous base, which reduces the possibility of increasing the cylinder's resistance to corrosion.

Then, it is possible to evidence, among the techniques previously presented, that laser cladding is a welding technique that deposits a welded layer on the substrate material, and it is possible to provide resistance to corrosion and equivalent or superior slide property than that of the substrate, in order to increase its resistance in harsh environments for extended times and lower maintenance requirements.

Laser cladding is a process that protects the substrate material by a liner layer, usually a special alloy, which improves its chemical, physical and mechanical properties. In addition, the laser is a preferred technique among other welding techniques, due to the fact that deposition uses minimum dilution of the substrate material.

The economic importance of laser cladding results from the feasibility of application of expensive materials, chosen due to their properties, and by depositing them on a common substrate material of low-cost metal, where they are required for better performance of their specialized functions. The substrate material provides most of the structure and reduces costs of the end user up to 40% in terms of special alloys deposited via laser cladding.

As shown in FIG. 2, the deposition technique of a liner via laser cladding also uses, in addition to the substrate, a source of energy that generates a laser beam, a feed injection nozzle, in this case fed with a powder. Another technique used for laser cladding is the pre-deposition of powder by a binder on the substrate material, where the laser only melts the material previously placed on the surface to be clad. The generated laser melts the substrate, by forming a pool, over which the material is deposited on the substrate, forming a liner.

The laser cladding, which is the process proposed for this invention, involves massive introduction of complex anti-corrosive metallic alloys, with eventual formation of carbides, nitrides or even other particles for friction reduction, which will be present in the high-temperature melting puddle created on the substrate surface by the laser beam. The major target of addition of other elements in the deposition is the improvement of resistance to wear, friction reduction, increase of resistance to seizing and slide behavior. The morphology and material of the particles must be very well controlled in order to prevent low adherence of the particles on the substrate material.

The method to produce the referred liner R on a slide component occurs when a powder compound is injected or previously placed on the substrate material surface, where the laser beam strikes the surface with an incidence angle of 45° to 90°, with powder flow ranging from 30 to 100 g/min, at a deposition speed of 3-20 mm/sec, gas flow between 3 and 15 l/min, laser power ranging from 2 to 8 kW, (focus) blur between 80 and 300 millimeters and CO₂, Nd:YAG or HPDL Diode laser type.

Among other advantages of the laser cladding process, we may highlight the low dilution rates (less than 5%), lower quantity of filling material (economic importance), greater hardness and small zone thermally affected (ZTA). The table below illustrates the key advantages of laser cladding, when compared to TIG, which is the typical process used for welding different materials.

| | TIG | Laser cladding |
|---|---|---|
| Dilution rate | 10-40% | <5% |
| Deposition material | Large quantity and | Small quantity and |
| | even deposition | even deposition |
| Hardness values | Relatively low | Relatively high |
| Zone thermally affected | Large and wide | Small and narrow |
| Finish | Rough surface = | Smooth surface = |
| | low durability | long durability |
| Pre- and Post-treatment | Miscellaneous | Few |
| Dendritic structure | Coarse | Fine |
| Automation | Difficult | Easy |
| Portability | Available | Under development |

Among the benefits from laser cladding, we may include extra protection to components, and thus up to five times as much lifetime. Also, in function of the current technological level of laser technology, the process is considered fast, accurate and easy to be automated, thus increasing the productivity and reducing the rework time, as once the process is validated, it can be promptly adopted in a continuous and robust way.

In addition, other advantages of the laser cladding process, when compared to other methods, are listed below:
Process easily controlled;
Low machine wear, thus, lower operational costs;
Liner on components with complex shapes;
Remote processing control;
Local treatment, in a small area, in opposition of plasma spray and galvanoplasty;
Suitable for production line instead of batch processing;
Fast treatments;
The laser can be also used as high-accuracy tool of the cutting, welding and surface treatment machine.

Laser cladding lining involves many processing parameters, such as size of the local energy range, feed rate and powder flow. The process requires higher power laser and the sophisticated control of the distribution systems. Table 2 indicates some of the variables of the laser lining system.

| Parameters | Laser types | Raw material |
|---|---|---|
| Power density (Beam | CO₂ | Powder |
| energy per area) | | |
| Feed rate | ND:YAG | Wire |
| Powder flow | HPDL Diode | — |

CO₂ laser was initially used for laser-cladding lining due to its high power and good efficiency (near 10%). Nd:YAG and HPDL diode lasers are currently used successfully for laser-cladding lining. Due to its flexibility, Nd:YAG laser is used in combination with optical fibers and robots.

The evolution of the laser cladding technology makes this option a low-cost process. The major causes are:
Enhancements in the powder metallurgy and its distribution systems;
Utilization of pre-heated wire, instead of powder, to increase speed and efficiency, thus reducing dust and residues;
Incorporation of external power source to preheat the substrate (induction heating);
Option for liners on large surfaces in an efficient way;
High-efficiency Nd:YAG and high-power HPDL diode lasers;
Optimization of the size distribution and morphology of powders.

The materials commonly used in laser-cladding liners are carbon steel, stainless steel, cobalt- and nickel-based alloys and titanium alloys. The most common materials applied to provide resistance to corrosion, in addition to resistance to wear and seize for slide components are listed on table 3:

| Metallic | | |
|---|---|---|
| alloy | Solution | Description |
| Cobalt- | Corrosion | Cobalt-based alloys with high quantities of |
| based | and wear | chromium and molybdenum area versatile |
| | | alloys, capable of withstanding abrasion, |
| | | corrosion, heat, oxidation, impact and wear. |
| Iron- | Abrasion | Low-alloy steel - 6-12% Cr, Mo and Mn |
| chromium | and | Medium-alloy steel - 12-25% Cr, Mo, |
| | corrosion | Mn and Si |
| | | Abrasion, layers resistant to corrosion: |
| | | moderate prices and machinability |
| | | High-alloy steel - 25-50% Cr and Mo. |
| | | Generate high level of carbides, not |
| | | machinable. |
| Manganese | Wear | Austenitic steel. In case of inclusion of |
| steel | | nickel and molybdenum, the alloy becomes |
| | | also resistant to impact. |
| Nickel- | Corrosion | Selected to provide resistance to corrosion |
| based | and wear | and high temperatures when there is metal- |
| | | metal contact. |
| Tungsten | Abrasion | Alloys with tungsten carbide (WC) particles |
| carbide | | can be added in iron, steel, bronze, nickel or |
| | | cobalt matrix and provide high resistance to |
| | | abrasion when the impact is low to moderate. |

The laser cladding process is described below for a slide component, object of this invention:

(I)—preparation of substrate material 1;

(II)—setting of deposition parameters of the laser equipment together with adjustment of the powder deposition rate; adjustment of the deposition and gas speeds;

(III)—start of liner deposition on the substrate material 1;

(IV)—deposition of elements 2 and 3, or optionally of element 2 only, by considering an overlapping rate for each track of the laser beam;

(V)—Finish of the deposited surface according to the application.

Samples of components provided with the present cobalt- and nickel-based liner R (specifically rings) were tested on bench in a reciprocating tribological test equipment in order to analyze the respective resistance properties.

To simplify the description, the test comprises the application of a load amounting to 360 N during 4 hours on a ring that displaces towards a cylinder under lubrication conditions. The ring was specifically tested in reciprocating 10-mm motions at speed of 900 RPM. The table below provides more details on the test conditions.

| Parameters | Value | Unit |
|---|---|---|
| Maximum speed | 1 | m/sec |
| Stroke | 10 | mm |
| Normal load | 360 | N |
| Duration | 4 | hour |
| Oil | SAE 30 | |
| Temperature | Room | ° C. |
| Ring diameter Ø | 128 | mm |

Abrasive Al₂O₃ (0.06% weight) and SiO (0.02% weight) particles are added to the lubricant oil, which have the function of accelerating the wear results in the tests. The ring used has diameter 128 mm and thickness 3 mm.

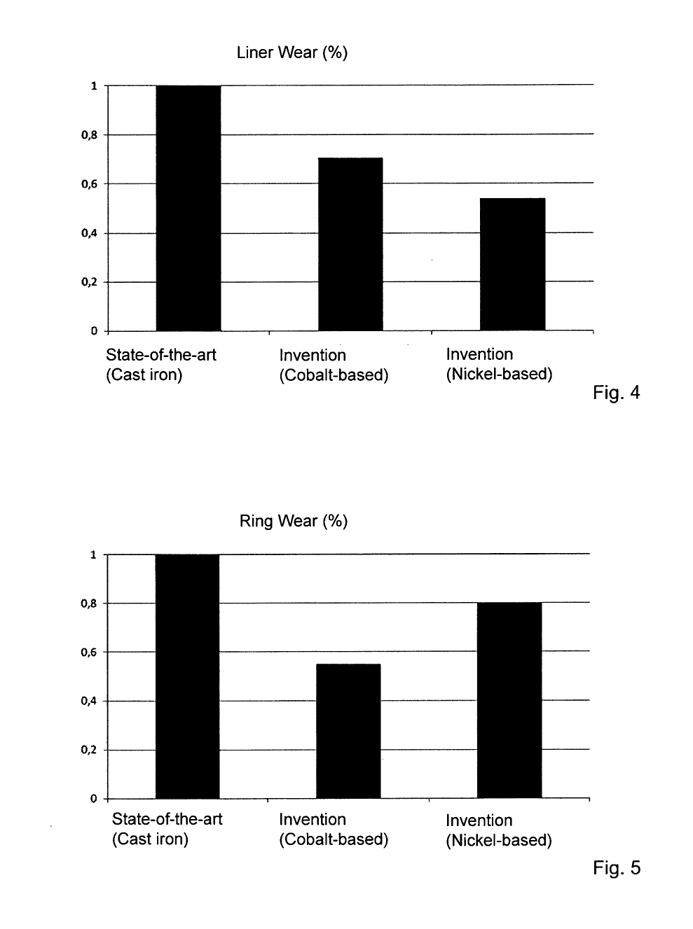

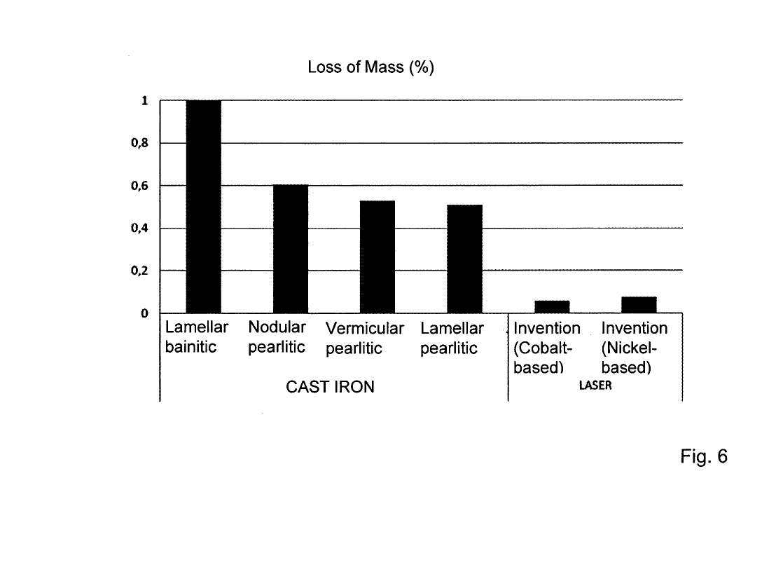

The comparative results between a ring provided with the liner of the former technique and the ring provided with liner R are shown on the charts illustrated in FIGS. 4 and 5.

Another important test performed was that related to corrosion, which procedure is:
providing square segments (2×2 cm) of the material to be tested, with at least 2 samples of each material to be tested.
protecting the non-coated area of these segments with a tape named as Tesa 4154®.
determining, as possible, the area of each segment and loss of mass (mg/cm²).
cleaning the segments with acetone, alcohol, ethanol and applying ultrasound during 5 minutes.
weighing the segments.
dipping the segments and a 2,000-mL flask, at a temperature of 50° C. by one hour.
cleaning the segments with acetone and alcohol, also removing traces of apparent corrosion by using ultrasound (100% power and 35% frequency, during 5 minutes).
measuring the segment weights again, which will enable obtaining the percentage loss due to corrosion.

Once described an example of preferred procedure, it must be understood that the scope of this invention encompasses other possible variations, which are limited only by the content of attached claims, including the eventual equivalent procedures.

1. A component of a slide system to be used in internal combustion engines, comprising a metallic base (1) with at least one surface coated with a protective liner (R), applied with a laser cladding process, wherein the liner comprises two essential elements (2,3), the first essential element (2) being more resistant to corrosion and the second essential element (3) being more resistant to wear and/or providing to the lining material a friction coefficient lower than a friction coefficient of the metallic base.

2. The component according to claim 1, wherein the first element (2) is selected from the group consisting of cobalt, nickel, chromium, molybdenum, aluminum and tungsten, at a percentage ranging from 60% to 90% in weight.

3. The component according to claim 1, wherein the second element (3) is selected from the group consisting of boron, carbon, niobium, vanadium, titanium and sulfur, in a maximum percentage of 40% in weight.

4. The component according to claim 1, wherein the first element (2) of the protective liner (R) is a metal-based material formed at least by cobalt, nickel, chromium, molybdenum and tungsten.

5. The component according to claim 1, wherein the second element (3) includes at least one of carbide, nitride and sulfide compounds in its composition.

6. The component according to claim 1, wherein the second element (3) of the protective liner (R) exhibits predominance of metallic elements.

7. The component according to claim 1, wherein the Vickers hardness of the liner is 300 HV to 1200 HV.

8. A component of a slide system to be used in internal combustion engines, comprising a metallic base with at least one of its surfaces coated with protective liner (R), applied with the laser cladding process, wherein the liner (R) comprises a composite with elements selected from the group consisting of cobalt, nickel, chromium, molybdenum, iron, aluminum and tungsten.

9. The component according to claim 1, wherein the base material is cast iron, steel or aluminum.

10. The component according to claim 1, wherein the total thickness of the liner (R) has values ranging from 50 μm to 500 μm.

11. The component according to claim 1, wherein the liner (R) is deposited by laser cladding process with powder injection or pre-deposition.

12. A method for production of clad on a substrate comprising the deposition of powder on the substrate surface (1) and by focusing a laser beam on the substrate surface (1), wherein the incidence angle is 45°-90°, powder deposition flow is 30-100 grams per minute, speed is between 3 and 20 mm/sec, laser power is 2-8 kW and (focus) blur is between 80 and 300 millimeters.

13. The component according to claim 1, wherein the liner (R) is free from pores and/or cracks.

14. The method according to claim 12, wherein the laser type is CO₂, ND:YAG or HPDL diode.
